(19) United States
(12) Patent Application Publication
(10) Pub. No.: US 2011/0057792 A1
(43) Pub. Date: Mar. 10, 2011

(54) Automated, Prescription Use Recording Device

(76) Inventor: James Frederick Fralick, Antelope, CA (US)

(21) Appl. No.: 12/491,156

(22) Filed: Sep. 4, 2009

(51) Int. Cl. G08B 21/00

(52) U.S. Cl. 340/540

(57) ABSTRACT

An automated container-use recording device is described. The device includes an interconnection device for connecting with a container and an active time keeping component for connecting with the interconnection device. The active time keeping component includes a trigger switch configured to generate a signal when the active time keeping component is removed from the container. A microchip is included that receives the signal from the trigger switch and records that a change of state of the container has occurred. A display is also included for displaying the change of state to a user.

### BACKGROUND OF THE INVENTION

(1) Field of Invention

The present invention relates to prescription monitoring device and, more specifically, to a method and device for automatically recording materials taken from a container.

(2) Description of Related Art

Containers have been made in the past for keeping track of items such as supplies, medication, or materials. These customarily are based upon resorting of the items and depositing them into a secondary device other than their original identified storage container.

In the past an individual's memory has been the primary record for determining the frequency of use or opening of a container. Manual or electronic logs were used by professional determining when supplies, medication, or materials were removed used.

Repackaging was an improvement in that the materials were re-dispensed in order to isolate the material in specific quantities. The problems with these methods are that they:
Remove labeling that tell others what the materials contain
Require accurate memory of repetitious and tedious tasks
Require refilling on a frequent basis
Require maintaining a log independent of the container to record dispensing
Often lead to speculation of use or dispensing of product

Dispensing materials or substances improperly could result in, or be an indication of:
Drug overdose
Inability to provide a Therapeutic dose of Medication
Theft
Product Tampering

Thus, a continuing need exists for a device that allows for an item (e.g., medication) to be stored in its original container under identical conditions while keeping precise record of each entrance to remove materials.

### SUMMARY OF THE INVENTION

The present invention is a method and device for automatically recording materials taken from a container. This automation may be done by either by affixing a device to the top of a modified bottle lid or by securing the device to an opening surface of a container door or flap. The semi-permanent connection between the container, flap, or door, to the device recording the movement between the surfaces is used to record usage. A battery powered microchip controlling the record keeping displays on an LCD or similar surface. The Micro chip is triggered by the movement between the surfaces initiating the record which is then displayed.

The advantages of the present invention are that the original containers are used, re-used and/or maintained. Information such as the containers contents and the intended dispensing instructions may be left fully in tact for future reference. Any modification of the contents is recorded automatically.

Optional features of this device vary on the intent of use. Prescription recording devices may be constructed to maintain a long term history of events.

Units with controls on the microchip may allow for review of historical data. Full featured units may allow for the setting of alarms for precise dispensing of substances or materials.

### BRIEF DESCRIPTION OF THE DRAWINGS

The objects, features and advantages of the present invention will be apparent from the following detailed descriptions of the various aspects of the invention in conjunction with the reference to the following drawings, where:

FIG. 1 is a top-view illustration of an automated recording device according to the present invention, depicting an active time keeping component;

FIG. 2 is a side-view illustration of the automated recording device, depicting the active time keeping component and an interconnecting piece to secure the recording device to a container;

FIG. 3A is a top-view illustration of an automated recording device according to the present invention, depicting the active time keeping component;

FIG. 3B is a side-view illustration of an automated recording device according to the present invention, depicting the active time keeping component;

FIG. 3C is a bottom-view illustration of an automated recording device according to the present invention, depicting the active time keeping component;

FIG. 4A is a top-view illustration of an automated recording device and active time keeping component according to the present invention, depicting an aspect where contacts are now sealed and secured in a housing modifying the means and methods of contact detection;

FIG. 4B is a side-view illustration of the automated recording device depicted in FIG. 4A;

FIG. 4C is a bottom-view illustration of the automated recording device depicted in FIG. 4A;

FIG. 5A is a side-view illustration of a connection medium for attaching the automated recording device to a container, which is an option and not required if electing to use the device for security;

FIG. 5B is a cross-sectional side-view illustration of the connection medium depicted in FIG. 5A; and

FIG. 5C is a bottom-view illustration of the connection medium depicted in FIG. 5A.

### DETAILED DESCRIPTION

The following description is presented to enable one of ordinary skill in the art to make and use the invention and to incorporate it in the context of particular applications. Various modifications, as well as a variety of uses in different applications will be readily apparent to those skilled in the art, and the general principles defined herein may be applied to a wide range of embodiments. Thus, the present invention is not intended to be limited to the embodiments presented, but is to be accorded the widest scope consistent with the principles and novel features disclosed herein.

In the following detailed description, numerous specific details are set forth in order to provide a more thorough understanding of the present invention. However, it will be apparent to one skilled in the art that the present invention may be practiced without necessarily being limited to these specific details. In other instances, well-known structures and devices are shown in block diagram form, rather than in detail, in order to avoid obscuring the present invention.

The reader's attention is directed to all papers and documents which are filed concurrently with this specification and which are open to public inspection with this specification, and the contents of all such papers and documents are incorporated herein by reference. All the features disclosed in this specification, (including any accompanying claims, abstract, and drawings) may be replaced by alternative features serving the same, equivalent or similar purpose, unless expressly stated otherwise. Thus, unless expressly stated otherwise, each feature disclosed is only one example of a generic series of equivalent or similar features.

Furthermore, any element in a claim that does not explicitly state “means for” performing a specified function, or “step for” performing a specific function, is not to be interpreted as a “means” or “step” clause as specified in 35 U.S.C. Section 112, Paragraph 6. In particular, the use of “step of” or “act of” in the claims herein is not intended to invoke the provisions of 35 U.S.C. 112, Paragraph 6. The method or arrangement of the wiring and components are well known by those with skill in the electrical and mechanical arts. An example is provided demonstrating feasibility of design as follows. As a central resource for the reader, it should be understood that several dominant components of the present invention are:
Active time keeping component 10;
Display 1A;
Microchip 1H;
Battery 1K;
Microchip accessible controls 1E; and
Trigger switch 1M.

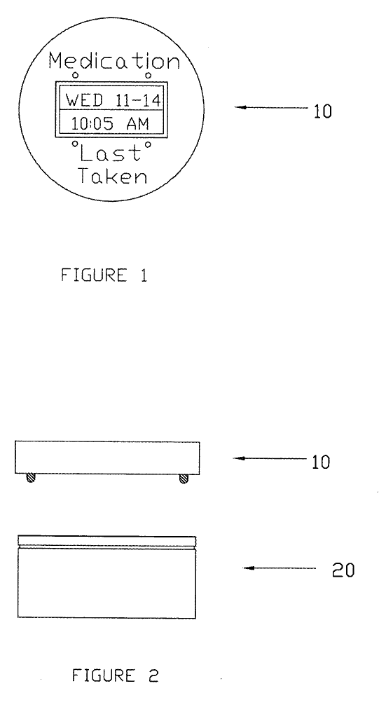

FIG. 1 provides a visual of the top of the automated recording device, depicting an active time keeping component (10), while FIG. 2 provides a side-view illustration of both the active time keeping component (10) and the inactive component (i.e., interconnection device (20)) of the automated recording device.

The inactive securing component (i.e., interconnection device (20)) shall be determined by the container to which it is intended to be mounted. In other words, the interconnection device (20) will be formed to connect with the active time keeping component (10) on one end and with a container (e.g., prescription bottle) on the other end. The interconnection device (20) will attach with a container using any suitable mechanism or device, such as threads or having elastic properties to allow it to be slid over the end of the container.

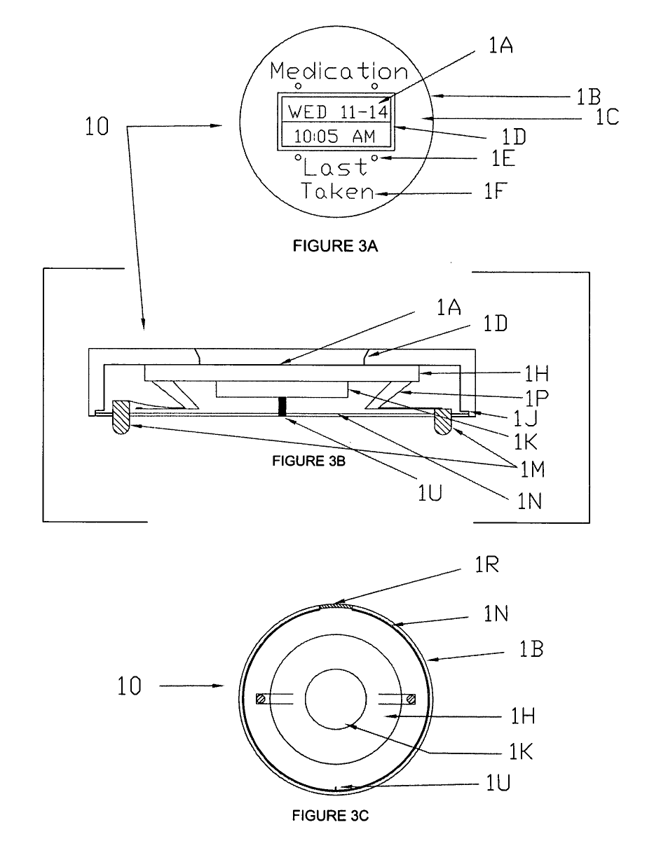

FIG. 3A illustrates the active time keeping component (10) and various subcomponents, including a display (1A) for displaying information that is being recorded. Also depicted are two housing components (1B and 1C). Further, a transition component (1D) from the housing (1C) to the display (1A) is included. Feature access buttons (1E) are provided as well as a generic information label (1F). As can be appreciated by one skilled in the art, the feature access buttons (1E) provide access and control to the various electronic features of the present invention, as described in further detail below.

FIG. 3B provides an exposed side-view illustration of a non-limiting example of the electronics used in the active time keeping component (10). The case transition (1D) location is shown as a reference point to assist the reader in viewing the corresponding components between FIGS. 3A and 3B. Designation (1A) indicates the location of the information display and, in this view, the symbolic component integration into the microchip (1H). A symbolic power source (i.e., battery) location is indicated by (1K), as is the electrical connection via leads (1P) to the trigger switch (1M). A physical connectivity location to the interconnection device (20) is shown by (1J), as is the retaining tab (1N).

Additionally, the trigger switch (1M) is depicted as a round post (as a non-limiting example) that is connected to a leaf spring which opens and closes when this contacts the edge of the bottle or container. The left side is normally open and the right side is normally closed when the lid is on. Either both open or closed can be used; however, alternating this combination provides a means to alert for tampering and error checking the mechanics.

FIG. 3C provides a bottom-view illustration of the active time keeping component (10). Also depicted in FIG. 3C is the leaf spring concept described above. Further, slot (1R) has been provided as a location to insert a prying device to separate the active time keeping component (10) from the inactive connecting hardware (i.e., interconnection device). The retaining tab or ridge (1N) is illustrated, as is the aligning tab (1U). The aligning tab (1U) facilitates aligning of the active time keeping component (10) to the interconnection device (20) to allow the trigger switch (1M) to protrude through the interconnection device (20), directly or indirectly, to the container (not shown) in order to record changes in status of proximity. Approximate views of the microchip (1H), power source (1K) and trigger switch (1M) are provided as examples. Hardware attachments and space requirements are all driven by the electronic components of the day and the feature requirements of the designer, and well known to those with skill in the electronic and mechanical arts.

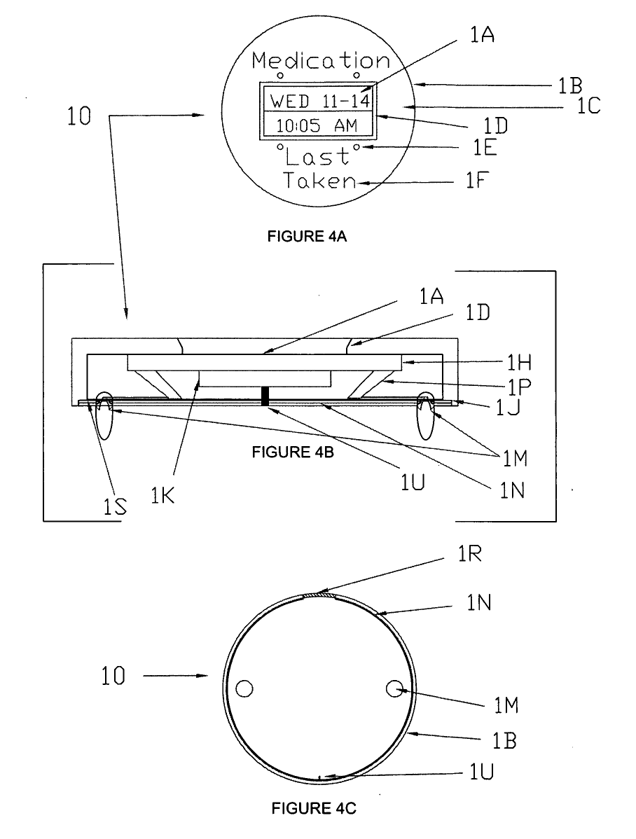

FIGS. 4A, 4B, and 4C are similar to that of FIGS. 3A, 3B, and 3C, except that wafer (1S) is used to enclose the electronic components and retain the switching contacts in a rubber enclosure. This would operate much like the push button of a phone dial in making contact only when pressed. Continuation of the active time keeping component (10) to connect directly to the desired container is also possible even though not shown. These assemblies, means, methods are well known by those in the mechanical and electrical arts.

More specifically, FIG. 4A illustrates an identical depiction as in FIG. 3A for the active components, while 4B provides a modification in the switching mechanism that is water tight and dust free. Further, FIG. 4C illustrates the enlargement of the pass through of the switching mechanism through which the device is triggered.

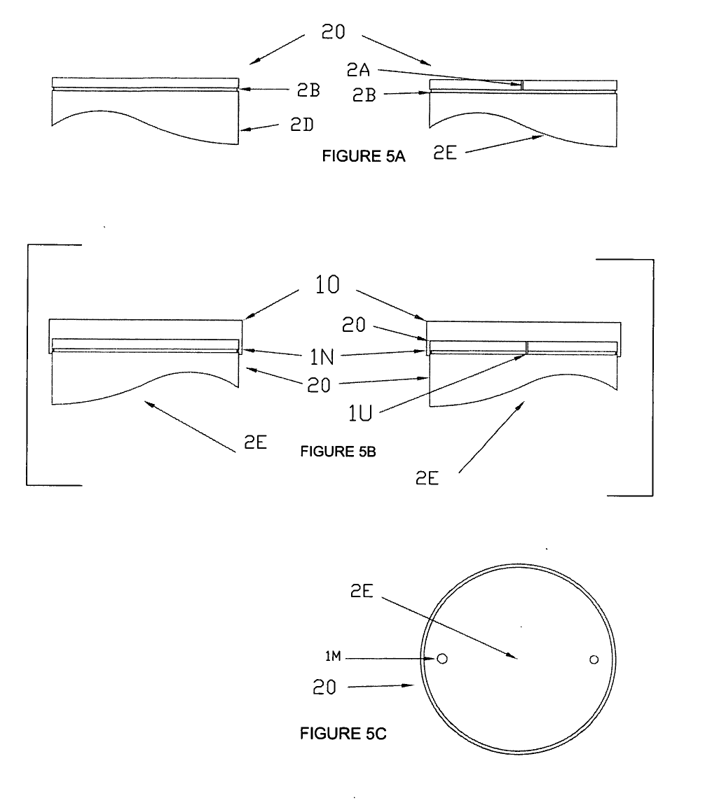

FIG. 5A shows a circular grove (2B) in the interconnection device (20) for retention of the active time keeping component (10) when the two units are pressed together. A grove for aligning the mating of the time keeping component (10) to the interconnection device (20) in position for the protrusion of the trigger switch (1M) (as shown in FIG. 5C) through the interconnection device (20) for contact with the container when the two are mated. Element (2D) depicts a typical bottle top or container top, while element (2E) depicts no specific means to connect to a container as none are restricted or specifically included.

FIG. 5B provides a cross-sectional, side-view illustration depicting the location of a ridge (1N) and, therefore, the implied grove that is depicted as element 2B in FIG. 5A. Also shown is a tab (1U) for alignment with a corresponding slot when the units are joined.

In operation, the microchip (1H) is a time keeping device having ROM/EPROM embedded program PROM (or similar electronic components) arranged to cause it to perform functions as desired. Desired information is displayed by a display (1A), a non-limiting example of which includes an LCD display. Construction of a protective translucent layer over this display and additional vandal proof covering over the remaining unit may be used when the device is engineered for security or theft of the contents within the container.

The microchip (1M) when triggered will display the time and date of the change in state of the container or, in some cases, a bottle. Triggering is completed by contact closure and/or opening of the trigger switch (1M), which is electrically connected with the microchip (1M) via the leads (1P). Triggering may also be attained by means of magnetic, optical, electrical resistance monitoring or pressure sensitive switching devices (all of which are referred to as a trigger switch (1M)). Triggering may be completed by a multitude of combinations known to those in the mechanical can electrical arts. Thus, in essence, when a user opens the container by removing the active time keeping component (10) from the interconnection device (20), the trigger switch (1M) or other triggering mechanism is activated which provides a signal to the microchip (1M) to mark the event as a change in state of the container.

Other options include attaining a historical data record when a user presses the appropriate series of contacts (1E), as depicted in FIG. 4C. The contacts (1E) are buttons or other devices that allow a user to control or otherwise interact with the microchip (1M) and active time keeping component (10). Upon deciding what information the designer intends to provide, a menu containing instructions on button operation may be developed and provided to the user as is well know by those in the electrical and mechanical arts. The size and shape of this device will be determined by the features desired and the container which it is monitoring.

The contacts (1E) may also provide access to audible alarms when programmed by the use for specific times and/or dates. Programming takes place by pressing the contacts (1E), in the proper sequence to achieve desired results. The contacts (1E) also allow the user to change time and date of the device by using the features available.

As noted above, within the device is an example of a battery power source (1K), capable of supporting operation of the time keeping electronics for a period of weeks, months, or years depending on the designers' intentions and well know by those in the mechanical and electrical arts.

As can be appreciated by one skilled in the art, attachment of the active time keeping component (10) to the interconnection device (20) to secure the recorder to a container is one means of allowing access to replacement batteries or changing connecting mechanisms while retaining an individual time keeping device. Engineering of one such attachment is provided in FIG. 5B.

What is claimed is:

1. An automated container-use recording device, comprising:
an active time keeping component for connecting with a container, the active time keeping component including:
a trigger switch configured to generate a signal when the active time keeping component is removed from the container;
a microchip configured to receive the signal from the trigger switch and record that a change of state of the container has occurred; and
a display for displaying the change of state to a user.

2. The automated container-user recording device as set forth in claim 1, further comprising an interconnection device for connecting with a container and the active time keeping component, thereby affixing the active time keeping component with the container.

3. The automated container-use recording device as set forth in claim 2, wherein the microchip is further configured to display a time and date of the change in state of the container.
